(19) United States
(12) Patent Application Publication
(10) Pub. No.: US 2006/0229959 A1
(43) Pub. Date: Oct. 12, 2006

(54) Customized automation of financial asset trading

(76) Inventors: Yaacov Heidingsfeld, New York, NY (US); Ron Resnick, Haifa (IL); Ehud Shalev, Givat Shmuel (IL)

Correspondence Address: KLAUBER & JACKSON, 411 HACKENSACK AVENUE, HACKENSACK, NJ, 07601, US

(21) Appl. No.: 11/101,186

(22) Filed: Apr. 7, 2005

(51) Int. Cl. G06Q 40/00

(52) U.S. Cl. 705/35; 705/37

(57) ABSTRACT

The present invention pertains to a system and method by which a financial assets trader (e.g., bank/broker/foreign currency manager) who normally executes trades in the financial assets marketplace may be able to process orders with minimal human interference in a truly automated, yet customizable way, thereby avoiding that which would normally require manual filling. Customized automation utilizes streamed rates and may be provided according to a client and/or institutional preferences by use of specific execution rules.

### FIELD OF THE INVENTION

The present invention relates generally to methods and systems for providing customized, automated financial transactions involving different financial assets such as foreign exchange, money market instruments (government or corporate debt, mortgages, etc.), interest rate instruments (swaps, etc.), commodities, equity instruments (stocks, warrants, etc.), and derivative instruments (options, futures, forwards, etc.).

### BACKGROUND OF THE INVENTION

Known systems for the trading of financial assets as used by banks, brokers and futures/commodities merchants orders, typically involving different type of detailed orders such as Limit or Stop orders, are usually maintained in an Order Book by a trading desk, and are monitored until the market price ‘hits’, thereby triggering their execution. More often than not, executing a “hit” order is a manual activity performed by a trader. This leads to inefficiencies and errors, given the intensive human involvement required.

In limited cases, attempts have been made to automate the financial asset marketplace. However, in such attempts there are severe drawbacks that limit the usefulness of the proposed systems. By way of example, one known attempt relates to an order management system known as the Telerate PassBook system, which is used within the foreign exchange marketplace and attempts to provide an automated order filling process. However, this system does not offer a flexible, rules-defined system as described herein. Furthermore, the Telerate system does not provide true automation, as it does not have an order management system closely coupled to a dealing system, and as such, cannot offer live streaming of dealable rates. Nor is the Telerate system alone in this shortcoming, other known systems have the same inflexible requirement of requesting rates ad hoc. Requesting rates ad hoc limits the functionality of trading the different financial assets, and renders any attempts at “automation” meaningless.

One further example of known attempts at automation may be seen in U.S. Pat. No. 5,787,402 “Method and System for Performing Automated Financial Transactions Involving Foreign Currencies” (hereby incorporated by reference in its entirety), issued to Potter et al. (“Potter”). Potter, like other attempts in the prior art, merely teaches a system with an ad hoc request for rates mechanism, and with no full automation to reduce human error. Moreover, Potter and other similar systems only have, at best, the capability to execute orders merely on a global ON/OFF basis only, with absolutely no customized flexibility, such as the ability to define an automatic execution for particular classes or types of orders.

In summary, there is simply no provision in the prior art systems for providing streamed quotes, and perhaps more importantly, there is no provision for a customized functionality for conducting transactions according to individualized needs.

### SUMMARY OF THE INVENTION

It is therefore an object of the present invention to provide a system and method by which a financial assets trader (e.g., bank/broker/foreign currency manager) who normally executes trades in the financial assets marketplace may be able to process orders with minimal human interference in a truly automated, yet customizable way, thereby avoiding that which would normally require manual filling. Customized automation may be provided according to client and/or institutional preferences by use of specific, customized execution rules. Trading according to the inventive system and method saves considerable time and money by permitting human trading staff to function more efficiently with minimized human errors and by allowing such staff to focus on complex and/or special attention orders.

It is a further object of the invention to offer flexibility of such automation through the rules-based auto filling of many different financial asset trades, such as money market instruments (government debt, corporate debt, mortgages, etc.), interest rate instruments (swaps, etc.), commodity instruments (exchange traded futures for metals, livestock, grains, etc.), and equity instruments (stocks, warrants, and derivative instruments including options, futures, forwards and swaps based upon various underlying asset types).

Lastly, it is an object of the invention to provide further flexibility by providing a streamlined approach through which a user of the system need not by constrained by required usage of the invention. The intent of the invention is to allow selective usage of the inventive process, such that it can be used in precisely the manner in which it aids the user, and need not be used for other orders if deemed unnecessary.

### BRIEF DESCRIPTION OF THE DRAWINGS

FIG. 1A is a diagrammatic representation of one embodiment of the overall environment in which the inventive system and method operates;

FIG. 1B is a diagrammatic representation of one embodiment of the generalized steps and actors involved in having the applicable rules be set up and in having the inventive Autofill process of the inventive system and method run internally at a user's (trading bank's) site;

FIG. 2 is a top-level flow diagram outlining the steps involved in one embodiment of the Autofill process of the inventive method as it might interact with the Order Management system;

FIG. 3 is an inner level flow diagram outlining the steps involved in the creation of one embodiment involving the creation and management of the attributes, predicates, Expressions, and Hierarchy from the Autofill User Interface of the invention; and

FIG. 4 is an inner level flow diagram outlining the steps involved in the application of one embodiment of the Autofill rules of the invention when an exemplary order has hit its price target.

FIG. 5 is a diagrammatic depiction of an exemplary AutoFill rules hierarchy with hypothetical rules/time/minmax breakdown.

FIG. 6 is a diagrammatic depiction of an exemplary value date/limit types/liquidity provider source ID breakdown.

FIG. 7 are exemplary screen shots of the UI that may be employed at the customer side for selecting and transmitting the specifics, preferences, and results particular to an illustrative transaction to a trader.

FIG. 8 is flow diagram outlining the program level logic that might be employed in one embodiment when processing an exemplary FX transaction.

FIGS. 9 (a-d) and (e-g) are flow diagrams depicting the program level logic that might be encountered when processing various illustrative FX transactions.

### DETAILED DESCRIPTION OF INVENTION

Background Description of Straight Through Processing for Financial Asset Order Management.

In its broadest aspect, the present invention relates to a system method for flexible, customizable processing or “Autofilling” of transactions involving an order for various types of financial assets. In particular, the invention improves the executing of financial asset trades by allowing a trading desk to specify with a exact precision which orders should be auto-filled. Autofilling an order allows a hit order to be executed without manual intervention, thereby enabling Straight Through Processing (STP) of the order execution process. The ability to Autofill orders preferably requires that a live dealing system be coupled to an Order Management system, so that the Autofilling of a deal or transaction maybe automatically effectuated (if so desired) when the order is hit.

The invention provides the Autofilling through provision of sophisticated, rules-based processes the given transaction(s) based upon specific indicia of relevant information, such as specific desks, specific amounts, specific customers, specific value dates (tenors), specific liquidity providers, specific time windows, specific currency instruments. Such rules represent the sophisticated automation of many hitherto manual verification processes and are the automated embodiment of the desires of both the transaction client and the trader, which furthermore, are a virtual instantiation of the applicable industry and institutional customs and parameters governing trades. Thus, the invention provides the technical effect of transforming specific client requests pertaining to a given transaction into useable information that is available for truly automated processing through the desk trader, in concert with liquidity providers/banks, market sources, etc., so that transactions may be effectuated a customized, yet error-free, efficient manner.

Furthermore, in providing all of the above, the rules as described herein are subject to a cascading override policy. The rules can be cascaded in a variety of precedence hierarchies, and with a variety of combinatorial logic. Provision as such enables the trading desk to be able to specially process transactions that may be deemed “special”. Thus, the inventive system provides the option of Autofilling the vast majority of a order trader's normal work flow, yet offers the custom option of an override for the manual filling of special transactions.

The system and method will have modules for executing the steps in the above-described dynamic. The electronic modules will essentially transform client wishes regarding a transaction into an executable order that may be filled in accordance with set parameters, into a resolved transaction. These modules will generally perform the tasks of: identifying an order involving an asset, associating attributes with the order, associating predicates with the attributes, associating expressions with the predicates, receiving financial information relevant to the order, resolving the order based upon said financial information and in accordance with the expressions associated with the order. Within this broad description, there is further provision for supplemental functionality involving the ability to choose between a manual means and an automatic means in accordance with parameters associated with the order. The processing may involve ascribing attributes that are selected from the group comprising a desk ID, a customer ID, an asset ID, pricing information, etc. The various assets that may be processed in accordance with the above may be of a type selected from the group comprising indicia such as foreign exchange, money market instruments, interest rate instruments, commodity instruments, equity instruments, and derivative instruments.

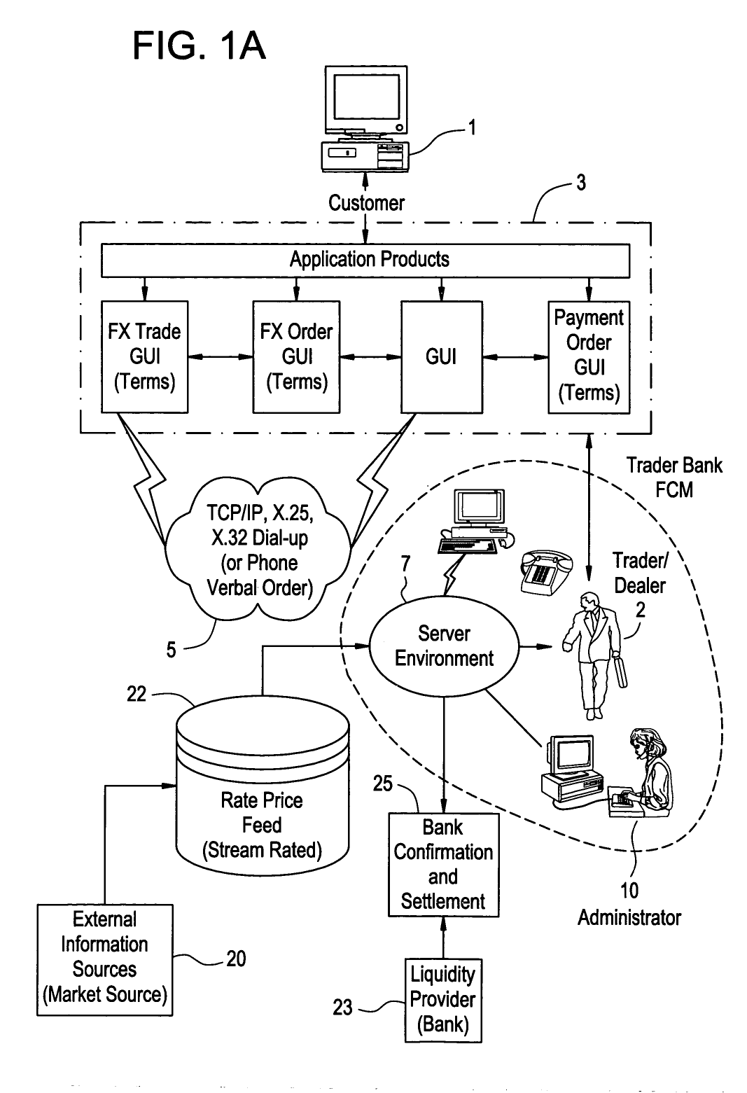

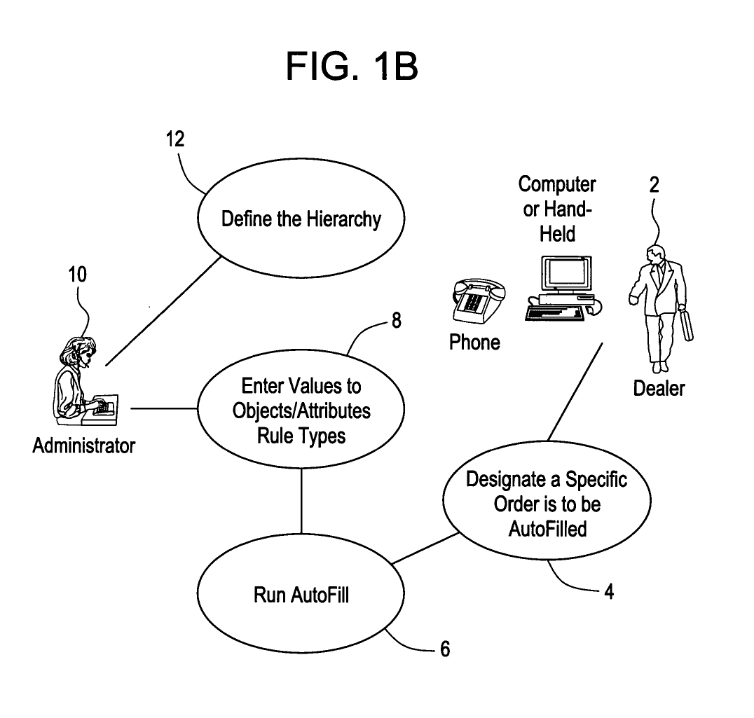

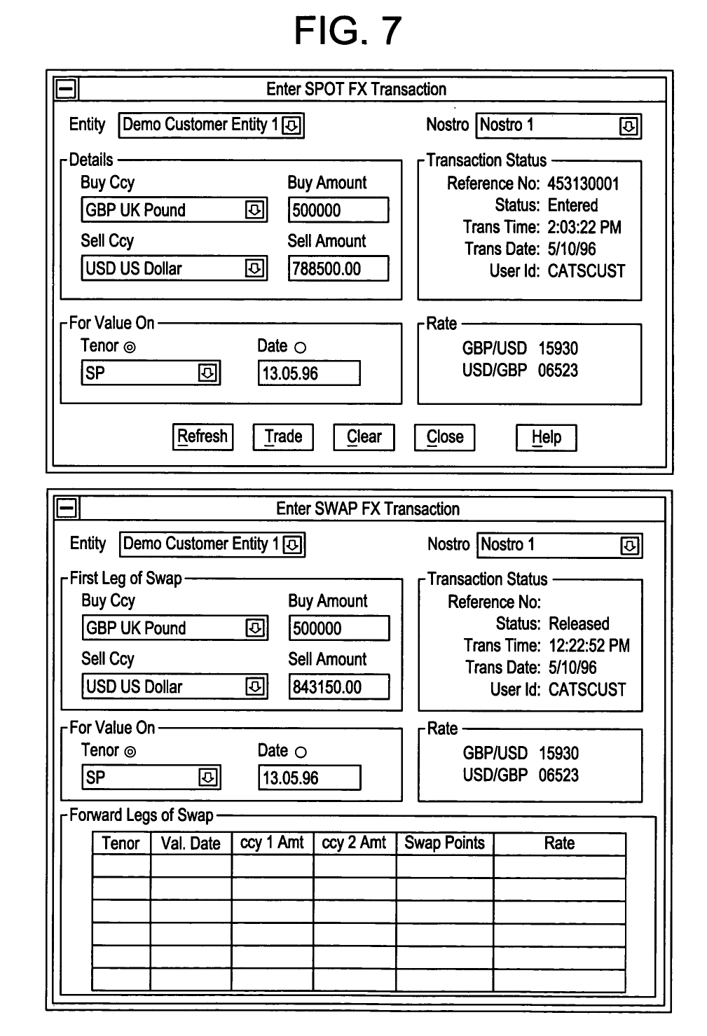

The inventive system may involve having the different modules described above situated at both the trader (trader bank) and client locations, or in remote electronic connection with one or both. Thus, as seen in FIG. 1A, the client or customer 1 may have a User Interface 3 (also referred to as order entry interface, an exemplary illustration of which is seen in FIG. 7), either provided by him or the trader, will preferably be one that may automatically format the relevant information automatically for transmission to/within the inventive system. In this case, the client may be conveying 5 an order or transaction to a financial transactions processing provider 2 (e.g., a trader, dealer or equivalent), from which he will receive a resolved order signal containing resolution information from the trader that is based upon the attributes described herein, whereby the attributes have been associated with predicates, and the predicates have been associated with expressions.

However, in one preferred embodiment, it is preferable for the modules to be all located either at the physical location of the trader, or in electronic connection therewith. In such a case, the trader will receive information from the client regarding the specifics of a proposed transaction, and may also receive information from a market source 20 regarding dealable rates 22. In an especially preferred embodiment, these two sets of information will be received in an electronic format via a network 7 so that the trader may allow for the Autofilling of the transaction according to the established parameters, through a bank 23. Thus, the trader 2 will have situated substantially connected to him modules that will execute the steps of: identifying an order involving an asset, associating attributes with the transaction, associating predicates with the attributes, associating expressions with the predicates, receiving financial information relevant to the transaction (such as the dealable rates that are streamed in from the market source 20), and then resolving the transaction in conjunction with the banks/liquidity providers 23 based upon the financial information and in accordance with the expressions associated with the transaction. In this vein, and as seen in FIG. 1B, the system and method will be interconnected between the trader 2, through network 7, so that administrator 10 may define hierarchy 12 so that when the values are received from the client (and the external market), they may be processed according to their objects/attributes rule types at 8. Hence, the Autofill may run 6 so that it can fill transactions that meet the criteria processed at 8, and were the trader has designated the specific order to be Autofilled at 4, either by default or by specific designation.

In general, and as referenced above, the inventive system may be used for many different types of financial asset trades for which an order has been received or proposed. For illustrative purposes herein, just one asset type, foreign exchange (hereafter also referred to as “FX”) will be described although, as one skilled in the art may appreciate, other financial asset types may be readily traded with the inventive system, all while achieving substantially similar advantages under equivalent configurations.

In one preferred embodiment, the inventive system and method (also referred to in part as “Autofill” herein) will be implemented and deployed within an automated financial assets trading platform, such as an FX trading platform that has, at a minimum, functionality like order management and FX dealing functions (not depicted). Preferably, the inventive system and method will be deployed within a trading system that has the following characterization: (i) limit orders are maintained on the trading system, and are monitored with respect to a moving market price (ii) at the time the market price satisfies the condition for execution of the order, an execution instruction is required to fill the order (iii) an execution order has the capability to be filled either manually by a trader, or automatically by a computer system (iv) the decision to fill the order manually or automatically be triggered by specific criteria of the order itself, and the conditions for its fulfillment. To this end, the inventive system shall therefore be described herein as operating within the framework of a proprietary FX trading system Trading Platform called STPlatform™, available through TraderTools LLC, of New York, N.Y. In this regard, both the STPlatform and U.S. Pat. No. 6,823,359, relate to the explicitly incorporated functionality known as “streaming” as referenced herein, and to this end, both are accordingly hereby incorporated by reference. Incorporation of the inventive system and method within this novel trading system provides for the additional advantage of this automation as provided for from streaming capability.

The inventive system and method as utilized with the STPlatform may in one embodiment be deployed partially within the premises of a trader bank/broker/FCM (hereafter collectively referred to as the “user(s)”) premises, and partially outside the user premises, at the users' customer sites. When utilized within the STPlatform, the invention offers a comprehensive solution for the user which in the one illustrative case described herein, might be banks and other FX originators who would then be able to provide automated FX dealing and order management services to their customers. Thus, the preferred exemplary trading platform in which the inventive system and method would interface in the illustrative embodiment, consists of a set of integrated modules for FX rate creation (RateTools), Order Management (hereafter referred to as OrderTools), Dealing (hereafter referred to as DealTools), publish/subscribe messaging (hereafter referred to as StreamTools), as well as complementary modules for functionality such as Real Time Collateral Management (hereafter referred to as CMS), Price Calculation for Synthetic Instruments including Forwards and Swaps (hereafter referred to as EZPoints and EZCalc), Best Price calculation, and Spread Management.

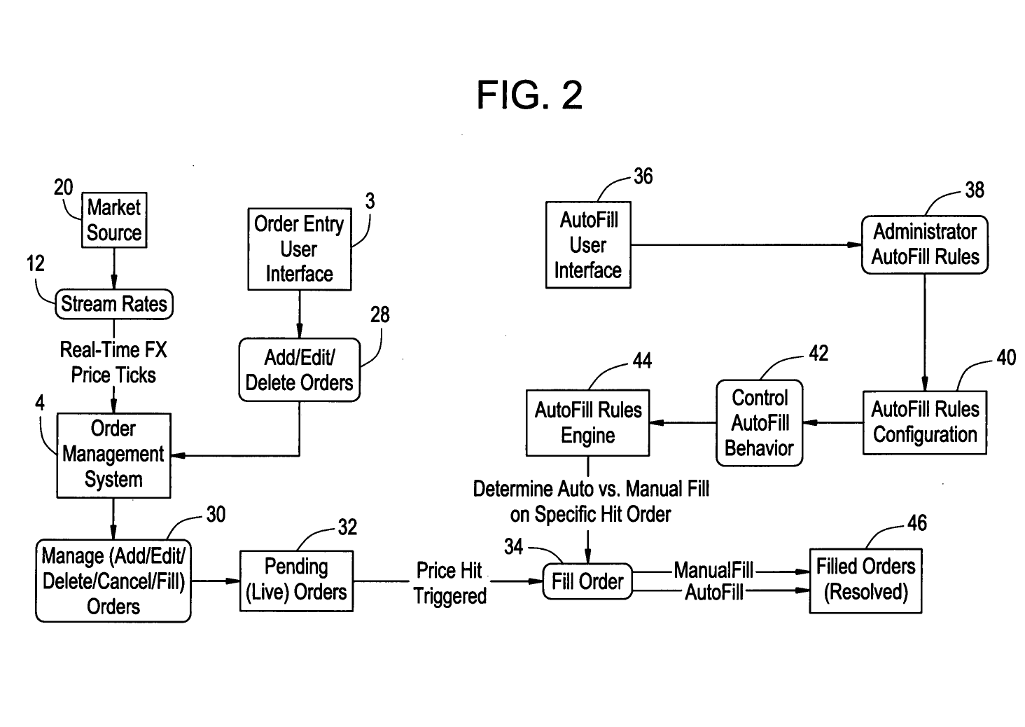

With ongoing generalized reference then to FIGS. 1A, 1B, 2, 3 and 4, the inventive system and method in one preferred embodiment, is configured so as to operate within a preferred, novel platform like the STPlatform that supports a technique of FX rate creation and publication known as “streaming”, seen as the streaming of dealable rates at 22 that emanates from market source 20. The importance of the streaming technique is that it provides a stream of real time, updated prices to traders' screens for complete automation, as opposed to the more conventional ad hoc technique known in the industry as a Request for Quote (RFQ). Furthermore, the STPlatform supports an automated Deal Export to the back office system of a dealing bank 23, and also supports automated “Back To Back” (hereafter referred to as B2B) dealing to external liquidity providers. These two capabilities, integrated with streaming dealable rates and the rest of STPlatform features, permit FX deal processing to be performed by a trader bank or Foreign Currency Manager (hereafter referred to as FCM) in an entirely automated manner, without manual intervention. Such automated deal processing is referred to herein as “Straight Through Processing” (hereafter referred to as STP).

Within a comprehensive trading platform like the STPlatform, the inventive system and method may then be offered as a complimentary STP service (known as Autofill) for order management through an order management system 24. The trading platform has an order management that allows customer orders (also referred to throughout alternatively as “trades” or “transactions”) from the UI 3 to be entered 28 by the client, monitored 30, 32, and (eventually) filled or otherwise resolved 46 by the trader 2, in conjunction with administrator 10, by use of a trader UI. Such a trading platform may then be able to accommodate many different types of sophisticated orders.

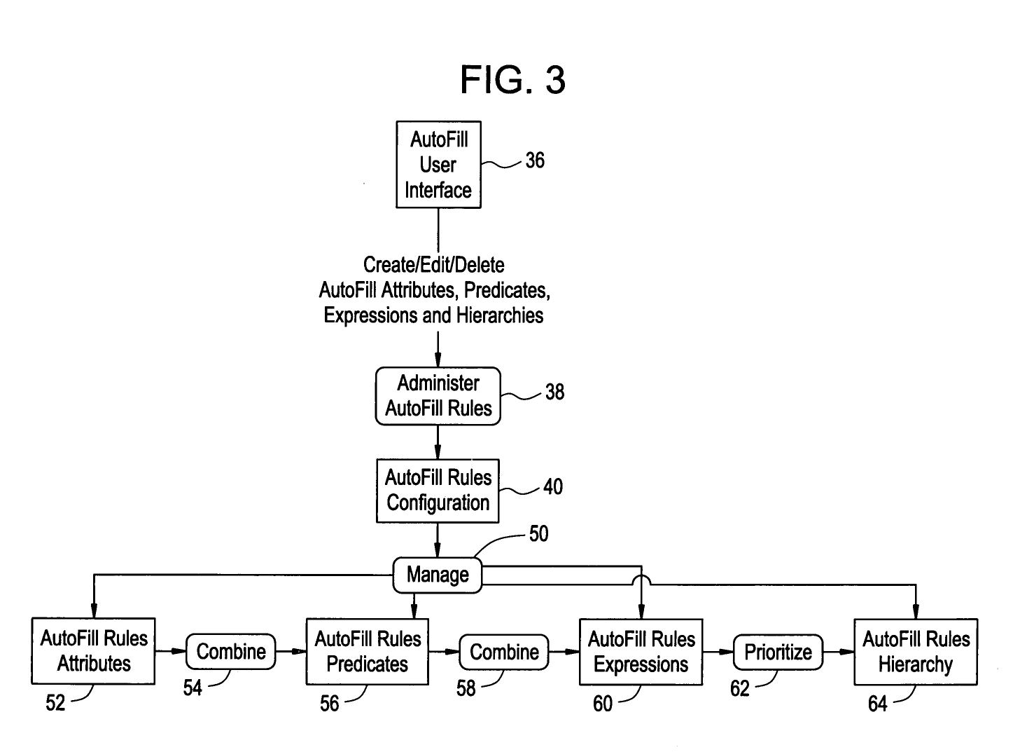

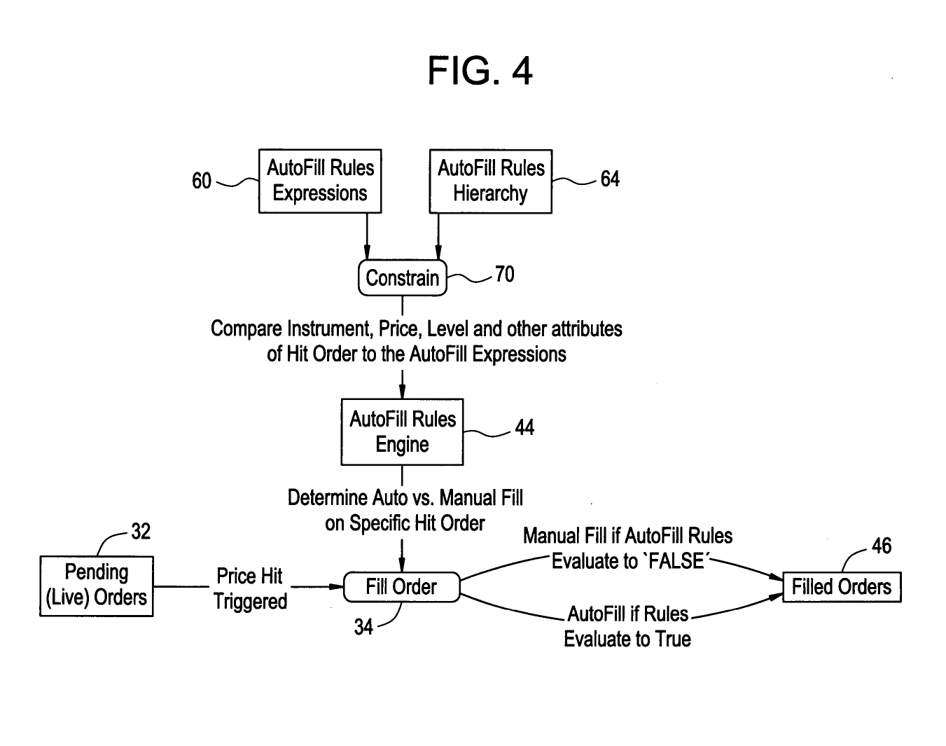

Specifically, this accommodation is best achieved through the use of the Autofill user interface 36, which is used to administer the Autofill rules 38, upon which the Autofill configuration 40 may be established, for the control of Autofill Behavior 42. This forms the foundation for the overall Autofill Rules Engine 44, which will allow an order or transaction to be filled 34 (or otherwise resolved if the conditions are never fulfilled in any case) when the price is triggered, either by manual fill or Autofill, so that the order is resolved at the completion 46. Thus, as seen in FIG. 3, it is the Autofill User Interface 36 that enables trader 2, in conjunction with administrator 10, to effectuate the Autofill attributes, predicates, expressions and hierarchies, so that there may be an automated administration of the Autofill rules 38, and for setting the Autofill Rules Configuration 40 (both of which are defined herein). When provided as such, it is possible to manage 50 the Autofill Rules Attributes (also called “attributes” herein) 52, and the Autofill Rules Predicates (also called “predicates” herein) 56, and the Autofill Rules Expressions 60 (also called “expressions” herein) as they combine into each other in the manner described herein, as well as the Autofill Rules Hierarchy 64 (also called “hierarchy” herein), which is a prioritization of the above. Accordingly, as seen in FIG. 4, once an order has hit its target price, the Autofill Rules expressions 60, and the Autofill Rules hierarchy 64 are used to constrain 70 the process by comparing the instrument, price, level, and other attributes of the hit order to the Autofill expressions. Once the hit order, as derived from the pool of pending (live) orders 32 has met it hit price and has been fully processed by the Autofill Rules Engine 44, then a determination is made as to whether the specific hit order is noted to be manually filled or automatically filled when the fill order stage is reached 34, and depending on the true/false value, the order is filled as a resolution 46.

By way of one illustrative example, orders like “Leave Orders” may be accommodated. These are requests by customers to execute an FX transaction not at the present time and market price, but at some future time and price, when specific conditions are satisfied. Continuing with this example, a “buy” “limit” order for USDJPY (US Dollar to Japanese Yen) @ 102.78 would be executed (or filled) only when the market price of USDJPY reached 102.78. Suppose that USDJPY is currently 102.40—in this case the order would be monitored until it is either cancelled, or until it reaches the target price (that is, when it becomes an “At The Money”—or “ATM” order). In addition to Buy Limit Orders, the inventive system and method also supports a wide variety of other sophisticated order types, such as Buy and Sell Limit Orders, Buy and Sell Stop Orders, Call Orders, Triggered Orders with If/Then or Order Cancels Order (hereafter referred to as OCO) logic. Additional order types like Loop Orders, Ratcheting Stop (also known as Trailing Stop) Orders, and Stop-Limit Orders, may be provided within. As one skilled in the art will appreciate, not all order types become eligible for filling when they are At The Money. Certain order types become eligible for filling when they are In The Money (“ITM”), Out of the Money (“OTM”), or when they reach yet more complex triggering conditions. Despite the inherent complexity involved in the numerous combinations of these various orders, the Boolean based rules described thereafter, will allow for any of these contingent conditions to be honored in an automated, error-free fashion according to a client's preferences and/or in line with industry practices.

As mentioned above, one of the novel aspects of the inventive system and method is the flexibility provided therein, such as the option to alternate between full automation (most orders) and limited automation (e.g. manual fill) so as to allow for special provision processing of extraordinarily complex or unconventional orders. When any active order satisfies the time/price conditions for it to be filled, the inventive system and method currently offers two basic modes of behavior: (1) Manual Fill (2) AutoFill. The AutoFill function may be set as either a global switch on the entire Order Management module, or may be custom tailored on a case by case basis (such as based on each order). Thus, AutoFill may be turned “ON” or “OFF” for any orders being managed. This is useful for a bank/FCM because, on a typical trading desk, it is desirable to Autofill routine orders which do not require manual intervention, yet flag complex orders for dealer action.

When turned “OFF”, this is deemed to be a “Manual Fill”. When this happens, the trader is alerted to the fact that the order is now ready for filling, and he is then responsible for manually executing a deal at the current market price which would satisfy the terms of the order. This deal may be a B2B Deal as described above, or not, depending upon the policies of the trading bank/FCM. When turned “ON”, the AutoFill performs automatically such that no trader is involved in filling the order. Rather, the order management system detects that a given order is a candidate for filling, and it directly invokes the DealTools subsystem of the STPlatform to perform the corresponding FX deal. Similarly, the AutoFill performs a straight through processing function in the sphere of order management comparable to the role performed by B2B dealing in the sphere of Deal Management. By combining both capabilities in one integrated platform, a trader bank or FCM can deploy a fully STP FX Trading solution for all contingencies and clients.

With further, more specific reference to the automated aspect of the invention, the present invention includes a sophisticated rules based “Autofill” service which can be customized by a trading desk to their own specific trading methodology. The inventive rules based Autofill service is based upon characterizing the component attributes of every FX order. A trader User Interface (UI) is provided to allow trader bank personnel to specify particular Boolean logic predicates regarding the attributes of orders being managed by the Order Management System. The UI further allows bank personnel to combine these predicates into Boolean logic expressions which evaluate to either True or False for any given order as set by the Administrator 10. The set of these Boolean logic expressions comprise the Configuration 40 for the AutoFill Rules Engine 44, the key software subsystem of the invention. The Rules Engine 44 is deployed in conjunction with the STPlatform in order to monitor in real time: (i) the set of active orders being managed by the Order Management System 24, and (ii) its own Configuration, that is, the set of defined Boolean logic expressions. When an active order being managed by the Order Management system becomes eligible for filling (e.g. a Limit Order becomes ATM or ITM), Rules Engine 44 evaluates the Configuration 40 expression applying to that order. Should the expression evaluate to True, Rules Engine 44 will determine that the order should be Auto Filled, and will issue messages to the Order Management and Dealing Systems to Auto Fill the order. Should the expression evaluate to False, the Rules Engine will determine that the order should not be filled, and will issue messages to the Order Management system to enable Manual filling of the order.

As seen in the previous description, the key element of the invention is Rules Engine 44, and its Configuration 40, both of which are essentially comprised of Boolean logic expressions based upon attributes of the orders themselves. The invention further specifies: (i) a specific set of order Attributes; (ii) a specific set of Boolean logic predicates which can be formed based upon these Attributes; and (iii) a specific set of Boolean logic expressions composed from those predicates, as detailed in the example below.

Attributes. The following attributes may be associated with each FX order:
1. Desk ID. The Trading Desk (e.g. New York, London, Tokyo) which owns the Order
2. Instrument Type. May be Spot, Outright Forward, Swap, Option, etc.
3. Customer ID. The Customer associated with this Order (e.g. FSMITH)
4. Instrument ID. The specific instrument associated with the Order. E.g., Spot instrument such as USDJPY, GBPUSD, or Forward instrument such as USDJPY17SEP
5. Order ID. A reference to a specific, unique order (e.g. Order ID # 14456325631)
6. Time. The current time at which the Order becomes eligible for filling (e.g. 15:40:20).
7. Quantity. The notional amount of the Trade to be executed when the order is filled (e.g. 5,000,000 USD).
8. Value Date (Tenor). The Date at which an executed Trade will be cleared according to the international Foreign Exchange settlement procedures. For a spot transaction other than USDCAD, this will be two days hence. For spot USDCAD, it is one day hence. For an Outright Forward or Exchange For Physical (EFP) Instrument, it will be at some future date associated with that specific instrument. E.g. USDJPY17SEP will have a Value Date of September 17.
9. Limit Type. May be Stop, Limit, Call, Stop-Limit, Loop, etc.
10. Liquidity Provider. Identifies an external Liquidity Provider—a Trader Bank/FCM providing FX rates to this Bank. E.g., banks such as UBS, Deutsche Bank, Citi and others typically supply FX liquidity in the InterBank market. In the context of a candidate order, the Liquidity Provider attribute identifies the Liquidity Provider which has provided the FX rate against which the order is being compared, and against which it will be filled. If B2B dealing is being employed, the order will be filled internally and then immediately a reverse transaction will be done against the external Liquidity Provider.
11. Triggered Orders. Identifies any Child Orders, presently dormant, which may be triggered and made active, once this Parent Order is filled. E.g. A “Take Profit” or “Stop Loss” Order (or both) may be associated with an Order, and be made active when the Parent Order fills.
12. Order Entry Type. May be Internet, Direct, or Batch. Identifies whether the order was entered by an external customer using the Internet based trading platform, by an internal Bank dealer, or through a Batch entry mechanism from an external Order Management System.
13. Allocation Table. Identifies the Allocation Table, if any, to be used in post-processing of the order after filling. An Allocated Order, when filled, will have the proceeds of the execution distributed among a set of accounts, rather than attributed to a single account. Orders not associated with an Allocation Table are attributed to the Account associated with the Customer ID.
14. Partial Fill. Identifies orders for which sufficient liquidity is available at the desired price to fill only part of the order, leaving the remainder of the order unfilled.
15. Aggregated Fill. Identifies orders for which sufficient liquidity is available at the desired price to obtain a complete fill, but only by executing multiple deals on multiple liquidity sources, such that the total deal amount equals the desired quantity.

It should be noted however, that the list of attributes above is not intended to be exhaustive of the set of relevant Order Attributes which can be part of the invention. The set of attributes is meant to be representative of the types of attributes found meaningful in discussions with STPlatform users. As one skilled in the art will readily appreciate, the invention can easily be extended to cover additional attribute types, depending on the user type, customer type, financial asset type, etc.

Predicates. Each of the order Attributes detailed above may be associated with a particular predicate logic exemplified below:
1. Desk ID. The Desk ID can be constrained to a specific Desk, or a specific set of Desks. E.g., DeskID={New York, Zurich} would evaluate to TRUE when the Order is managed on the New York or Zurich desks, but FALSE if the Order is managed in Singapore, Paris, or London.
2. Instrument Type. The Instrument Type can be constrained to a specific type or set of types. E.g. INSTRUMENTTYPE={SPOT, EFP} will evaluate to TRUE for Orders for Spot or EFPs, but FALSE for Broken Date Forwards or Swaps.
3. Customer ID. The Customer ID can be constrained to a specific Customer or set of Customers. The Predicate can also be specified using matching logic, such as a Regular Expression. E.g., CUSTOMERID=˜/$L.*MORGANˆ/ will evaluate to TRUE for Orders associated with LARRYMORGAN and LESTERMORGAN, but FALSE for JSMITH, LEEMORGANSON, and ELWOODMORGAN.
4. Instrument ID. The Instrument ID can be constrained to a specific Instrument (e.g. USDJPY), or to a set of Instruments specified using a Regular Expression. E.g., INSTRUMENTID=˜/USD/ will evaluate to TRUE for Orders associated with USDJPY, GBPUSD, and USDJPY17SEP, but FALSE for EURCHF or AUDCAD.
5. Order ID. The Order ID can be constrained to a specific Order ID or a range of Order Ids. E.g. 1440000000<=Order ID<=1445000000 will evaluate to TRUE for Order with ID 1440010000, but FALSE for ID 1540000000.
6. Time. A predicate may be defined to compare the current time of day to the Time Attribute associated with the Order, using =, <, >, <=, >=operators. E.g. 06:00<=TIME<=20:00 will evaluate to TRUE for Orders which become eligible for Filling between 6 AM and 8 PM (Local Desk Time), and will be FALSE between 8 PM and 6 AM.
7. Quantity. The Quantity may be constrained to a specific range, governed by MIN and MAX values. E.g., 2,000,000<=QUANTITY <=5,000,000 will evaluate to TRUE for Orders specified for this amount of base currency, and FALSE for Orders for less than 2,000,000 or greater than 5,000,000.
8. Value Date (Tenor). The Value Date may be constrained to a specific range governed by MIN and MAX dates. E.g., 02APR05<=VALUEDATE <=01SEP05 will evaluate to TRUE for Orders for Spot or Forward instruments that settle between these dates, and FALSE for Orders for Spot or Forward Instruments that settle prior to Apr. 2^{nd}, 2005 or after Sep. 1^{st}, 2005.
9. Limit Type. The Limit Type may be constrained to a specific value or set of values. E.g., LIMITTYPE={STOP, STOP-LIMIT} will evaluate to TRUE for Stop and Stop-Limit orders, and FALSE for Limit, Call, and Loop orders.
10. Liquidity Provider. The Liquidity Provider may be constrained using a Regular Expression to a specific value or set of values. E.g., LIQUIDITYPROVIDER=˜/ˆ(D|C)/ will evaluate to TRUE when the Filling Rate is supplied by DB (Deutsche Bank), DRKW (Dresdner Kleinwort Wasserstein) or CITI (Citi Bank), and will be FALSE for UBS or BARCLAYS.
11. Triggered Orders. A predicate may be defined on the existence of Triggered Orders. E.g., HASTRIGGEREDORDERS will evaluate to TRUE for a Parent Order that has one or more dormant Child Orders, and False otherwise. Furthermore, Triggered Orders may be constrained on their Quantity or Limit Type. Note that a constraint on the Triggered Order applies to the AutoFill rule for the Parent Order. AutoFill rules for the Child Orders will be invoked only after a Child Order is activated, and itself becomes eligible for filling.
12. Order Entry Type. The Order Entry Type may be constrained to a specific value or a set of values. E.g., ORDERENTRY={DIRECT} will evaluate to TRUE when the Order was entered by a Desk Trader, and will evaluate to FALSE when the Order was entered by an external Customer over the Internet, or via a Batch importation from an external Order system.
13. Allocation Table. The Allocation Table may be constrained using a Regular Expression to a specific Customer account or set of Customer accounts found within the Allocation Table. E.g., ALLOCATIONTABLE=˜/ˆ15776\d{4}$/ will evaluate to TRUE for an Order that has an Allocation Table, and which contains Customer Account 157761234. It will evaluate to FALSE for orders that do not have an Allocation Table, or which have an Allocation Table that does not match the regular expression for Customer Accounts.
14. Partial Fill. The Partial Fill attribute may be constrained numerically on a percentage basis. E.g., PARTIALFILL>60 would evaluate to TRUE for an Order for 5,000,000 USD for which 4,000,000 USD can be filled immediately, since 4,000,000/5,000,000=80% surpasses the 60% threshold. If only 2,000,000 USD can be filled, the same predicate would evaluate to FALSE since 2,000,000/5,000,000=40% is less than the 60% threshold.
15. Aggregated Fill. The Aggregated Fill attribute may be constrained numerically by a count of the number of distinct Deals which would be required to fill the order. E.g., AGGREGATEDFILL<3 would evaluate to TRUE if an Order can be completely filled from one or two distinct liquidity sources, but would evaluate to FALSE if three or more sources were required. Note also that Aggregated Fill predicates interoperate with Liquidity Provider predicates, since a Liquidity Provider that satisfies part of the Aggregated Fill may trigger Auto Fill, while another may not.
16. Allocation Table. Identifies the Allocation Table, if any, to be used in post-processing of the Order after filling. An Allocated Order, when filled, will have the proceeds of the execution distributed among a set of accounts, rather than settled against a single account. Orders not associated with an Allocation Table are attributed to the Account associated with the Customer ID.

It should again be noted that the list of predicates above is not intended to be exhaustive of the set of relevant predicates which can be part of the invention. The listed set of predicates herein is meant to be merely representative of the types of predicates expected to be meaningful when using this invention. Of course, the present invention can easily be extended to cover additional predicates, based both upon the existing set of attributes, or additional attributes.

Expressions. The Predicates detailed above may thereafter be combined into Boolean logic expressions. By way of one exemplary embodiment, the present invention specifies a set of 3 hierarchies of precedence rules which embody the combinations of certain key predicates, namely the Desk ID, Customer ID, Instrument Type, and Instrument ID. These are also associated with a Global (Bank-wide) predicate which acts as a default policy of whether AutoFill should be enabled or disabled across the breadth of the system.

The following 3 hierarchies are thus defined:
1. Hierarchy Type 1=Global-Desk ID-Instrument Type-Customer ID-Instrument ID-Order ID
2. Hierarchy Type 2=Global-Customer ID-Desk ID-Instrument Type-Instrument ID-Order ID
3. Hierarchy Type 3=Global-Desk ID-Instrument Type-Instrument ID-Customer ID-Order ID

These hierarchies are mutually exclusive to each other, and each bank will have only one active hierarchy at a given time. The chosen hierarchy represents a scheme for lower levels to override settings for higher levels. Hence, for example, a setting for the Instrument ID in Hierarchy Type 1 will override settings for Customer ID, Instrument Type, Desk ID, and Global which reside above it.

Those attributes which do not belong to the Hierarchy Types given above are considered at equal precedence level in the Rules Engine, and expressions involving them are at higher precedence than the selected hierarchy itself. Thus, predicates formed based on these attributes, as specified above, may be combined using typical AND/OR/NOT/XOR Boolean logic into Boolean expressions. These expressions may be evaluated for TRUE/FALSE status, and the resultant expression takes precedence over the selected Hierarchy. Only in cases where no Boolean expression is defined for a given Order is the Hierarchy considered to evaluate the TRUE/FALSE status of the Auto Fill.

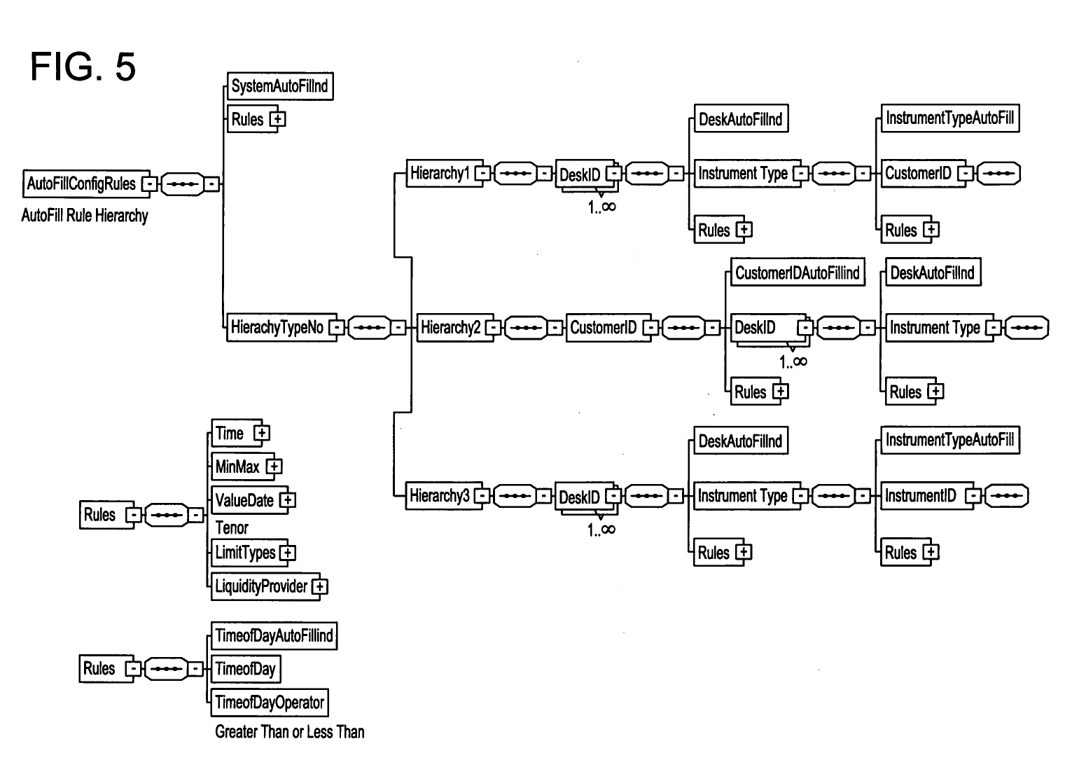

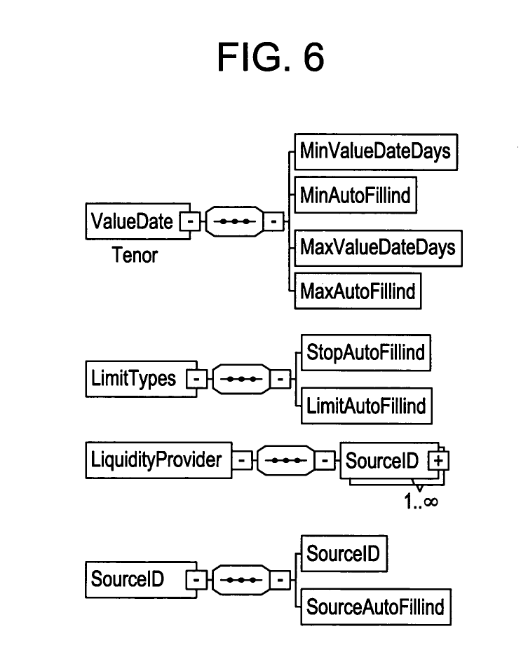

It should be noted that the intent of the hierarchies is to provide a convenience to Administrator 10 of Rules Engine 44. The Hierarchies (an exemplary rendering of which is depicted generally in FIGS. 5 and 6) simplify the task of capturing the most common types of Boolean expressions anticipated for use in Rules Engine 44. The Hierarchies are thus not a required part of the invention. A system without the Hierarchies, but which has Expression Building functionality that can be used to construct such Expressions, is effectively equivalent to the inventive system and method as described herein. Furthermore, it should be noted that the Expression structure given above, including the Precedence Hierarchies (alternatively referred to as “hierarchies” herein), is not intended to be exhaustive of the set of relevant Expressions which can be part of the Invention, and are illustrated as one possible embodiment. Hence, the Expression structures and Precedence Hierarchies herein are meant to be illustrative of the types of Expressions and hierarchies that are expected to be useful, and accordingly, the invention can easily be extended to cover additional expression types, based both upon the existing set of attributes and predicates, or additional attributes and predicates.

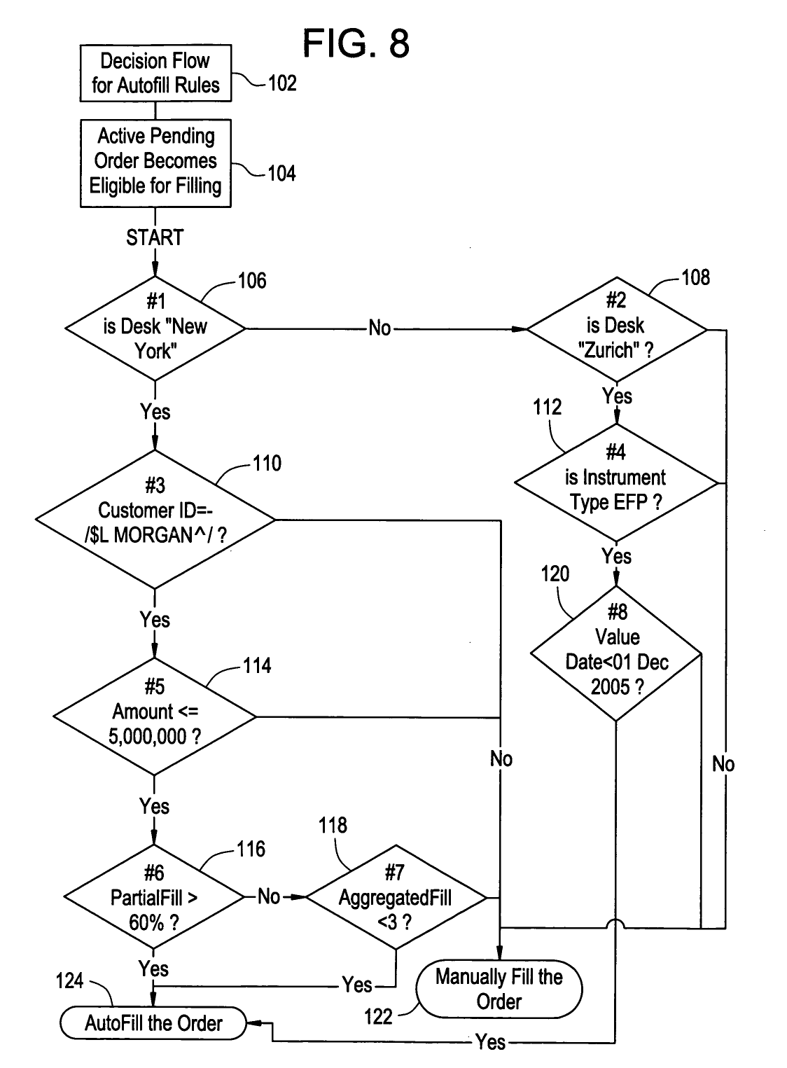

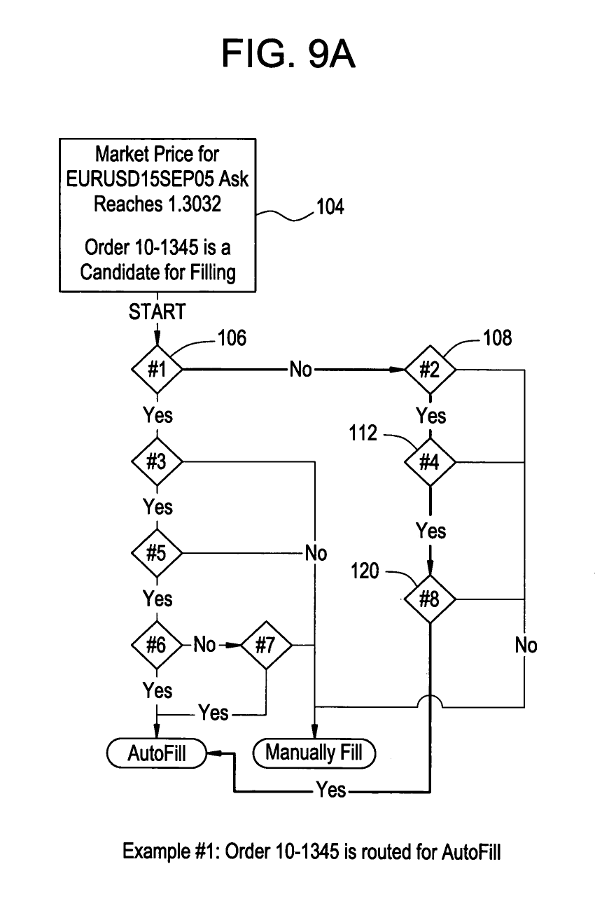

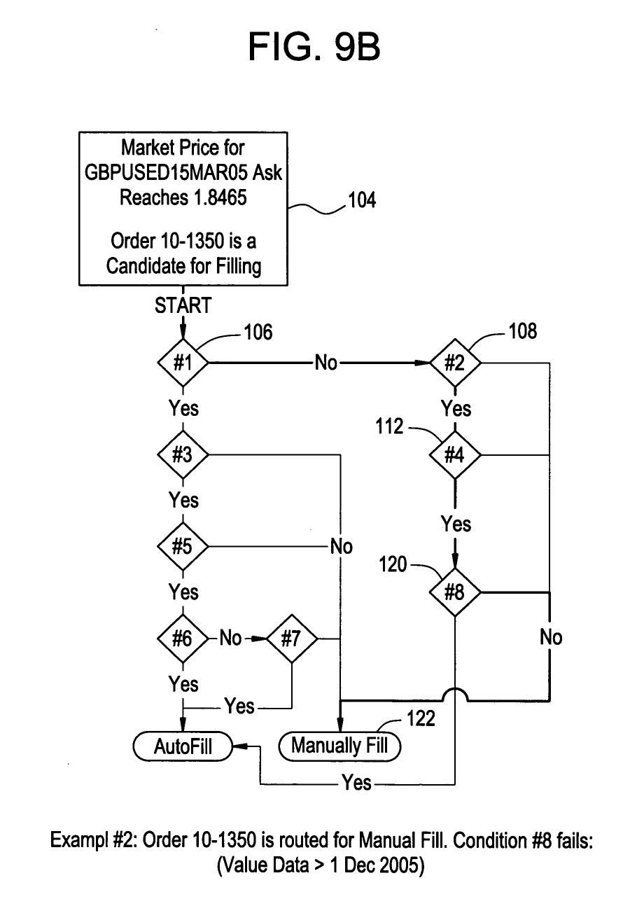

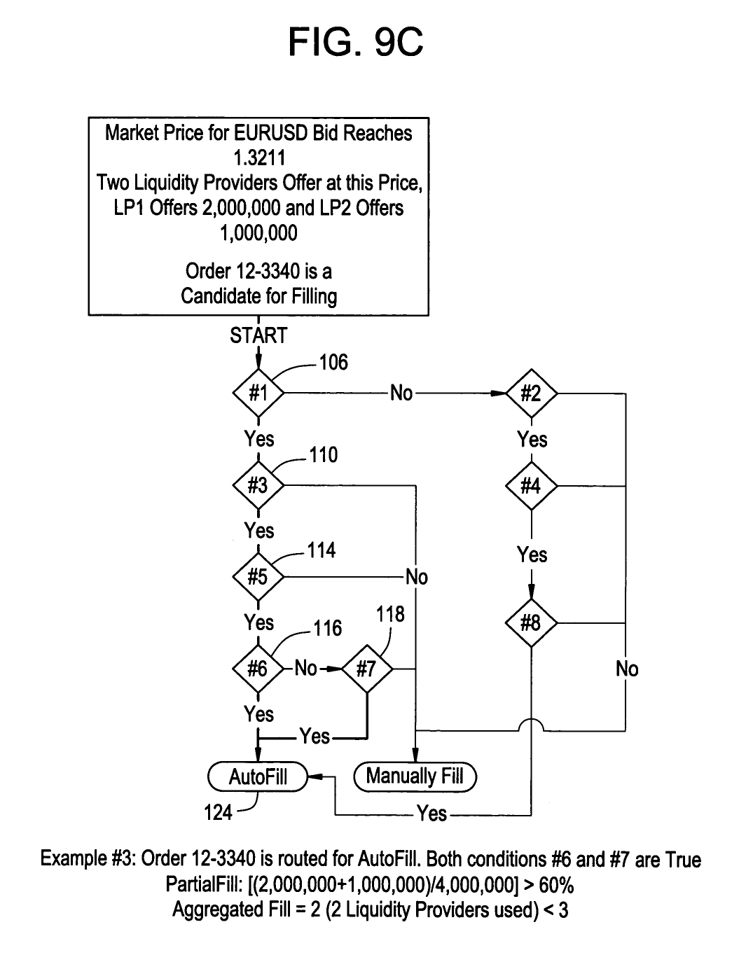

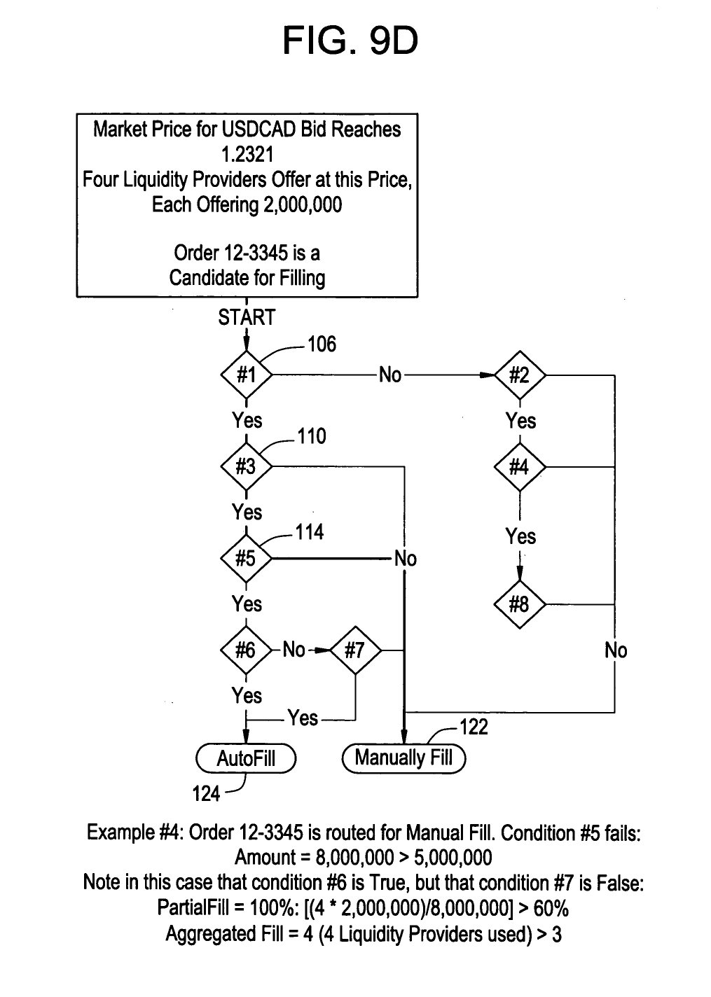

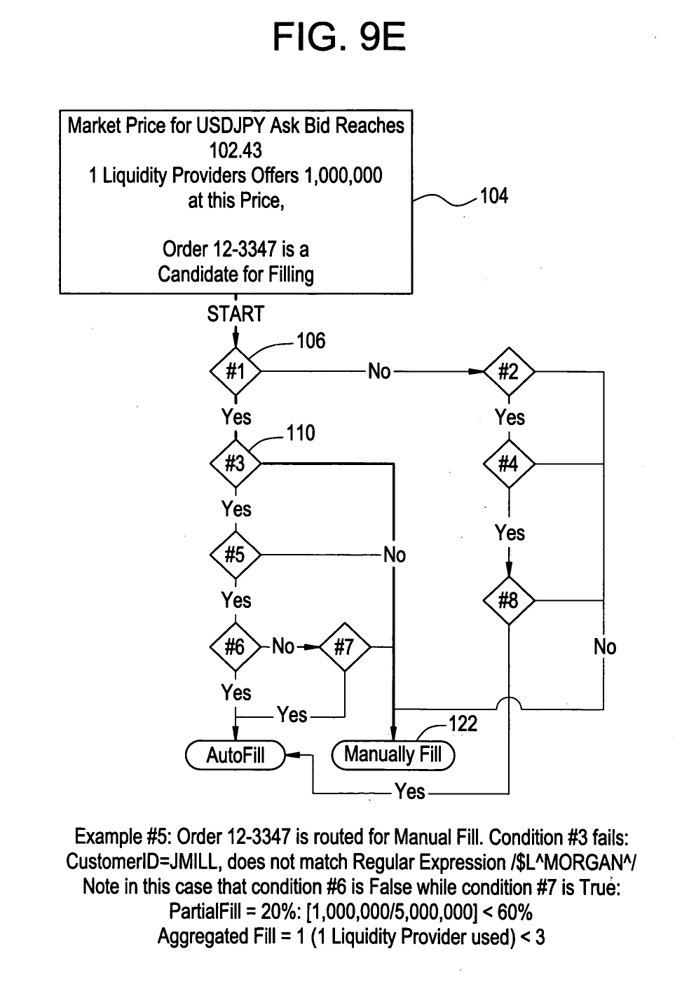

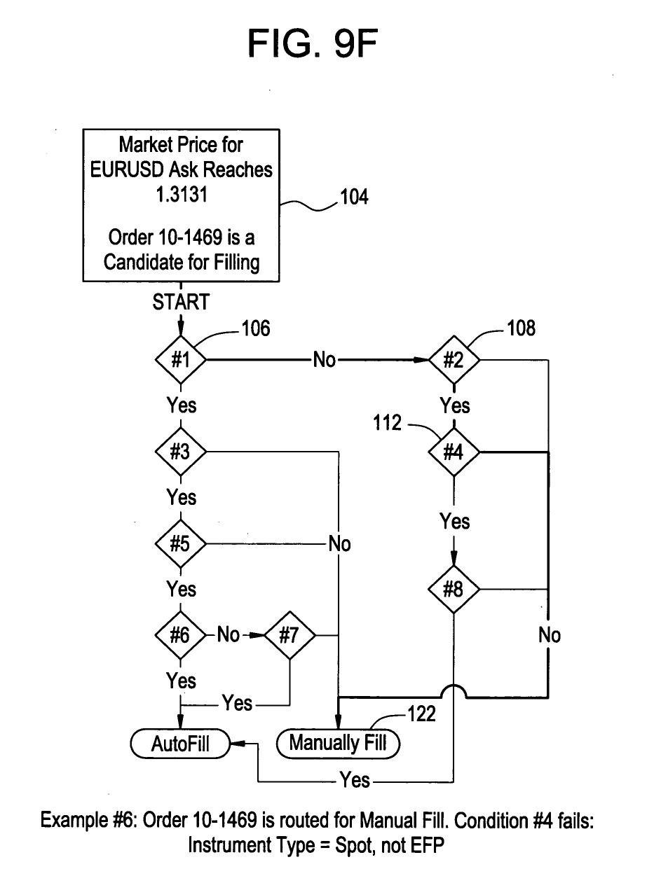

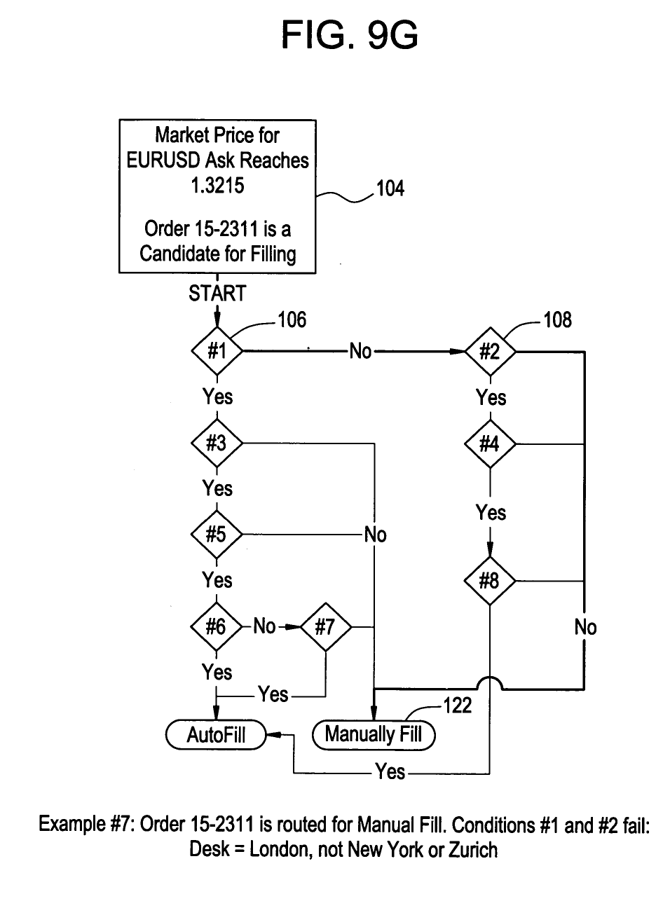

FIGS. 8 and 9 (a)-(g) illustrate, in one embodiment, a specific example of usage of the technique described by the invention. In this illustrative example, a hypothetical Bank provides Foreign Exchange trading to its customers. The Bank operates Desks in New York, Zurich, and London. The Bank determines that it wishes to set up customized Auto Fill rules for its three (3) Desks as follows: (1) Manually Fill all orders taken on its London desk; (2) In Zurich, Auto Fill all EFP (Exchange For Physical) orders which have a short-term value date prior to Dec. 1, 2005. All longer-term EFPs and all Spot orders in Zurich should be manually filled; (3) In New York, most orders are manually filled, but the following specialized cases of orders are Auto-Filled: only orders belonging to customers with first initial L and surname Morgan (e.g. Lee Morgan, Lester Morgan, etc.), and for amounts less than $5,000,000 are candidates for Auto Fill. Even among these orders, a further test is required. Orders must be EITHER 60% filled (in case of a partial fulfillment) OR filled by not more than 2 distinct Liquidity Providers.

Within the illustration of an FX transaction, depicted below is an exemplary table of pending orders and exemplary logic flow that might be involved in processing within the inventive methodology. Thus, the following tables illustrate the codifying of these Auto Fill rules, and a sample set of pending live) orders managed by the Bank on behalf of its customers:

TABLE A
Exemplary Pending (Live) Orders

| | Order | | | | | | | | | | |
|---|---|---|---|---|---|---|---|---|---|---|---|
| | ID | Order | Type | Amount | Type | Underlying | Valued | Customer | Desk | Value Date | Level |
| 1 | 10-1345 | BUY | LIMIT | 4000000 | EFP | EUR | USD | R Smith | Zurich | 15-Sep-05 | 1.3032 |
| 2 | 10-1350 | BUY | STOP | 2000000 | EFP | GBP | USD | F Jones | Zurich | 15-Mar-06 | 1.8465 |
| 3 | 12-3340 | SELL | LIMIT | 4000000 | Spot | EUR | USD | L Morgan | New | 1-Aug-05 | 1.3211 |
| | | | | | | | | | York | | |
| 4 | 12-3345 | SELL | STOP | 8000000 | Spot | USD | CAD | Lee | New | 1-Aug-05 | 1.2321 |
| | | | | | | | | Morgan | York | | |
| 5 | 12-3347 | BUY | LIMIT | 5000000 | Spot | USD | JPY | J Mill | New | 1-Aug-05 | 102.43 |
| | | | | | | | | | York | | |
| 6 | 10-1469 | BUY | LIMIT | 4000000 | Spot | EUR | USD | R Smith | Zurich | 1-Aug-05 | 1.3131 |
| 7 | 15-2311 | BUY | LIMIT | 4000000 | Spot | EUR | USD | T Green | London | 1-Aug-05 | 1.3215 |

With specific reference to one depiction, FIG. 8, is an illustration of an exemplary flow diagram corresponding to the Bank's Auto Fill rules for the above-referenced example. Each decision node is respectively labelled as Condition #1 (New York Desk?), Condition #2 (Zurich Desk?), Condition #3 (Customer ID?), etc. for shorthand reference in each of the cooperative flow diagrams hereafter (FIGS. 9 (a)-(g)). As seen in the decision flow for Autofill Rules 102, once an active pending order becomes eligible for filling at 104, the desk identity is queried n−1 times, in this case, there are three possible desks (e.g., n=3), so the system logic will query two serial default questions (respectively; decision node #1 (“Is Desk New York?”) at 106; if not, decision node #2 (“Is Desk Zurich?”) at 108; otherwise London) until a conclusive desk identity is determined. In line with the above referenced trading desk parameters, if the desk is “New York”, then the assigned trade rules for that station are thereafter assessed (customer ID at 110, amount limit at 114, and (partial fill minimum at 116 or aggregated fill maximum at 118)) until the order is Autofilled or until it is required to be manually filled. Similarly, if the desk is not “New York”, but is determined to be Zurich at 108, then the assigned trade rules for that station are thereafter assessed according to the settings (typically established by Administrator 10 in coordination with trader/dealer 2), such that the instrument type status (e.g., “EFP” or exchange for physical, etc.) is determined at 112, and subsequently, if of the correct instrument type (in this case, EFP), then the value data (e.g., established term limit, in this case, Dec. 1, 2005) is determined at 120. If any of these conditions or statuses fails, then the order will be manually filled at 122, otherwise it shall be Autofilled at 124. Lastly, if the desk identity is neither “New York” nor “Zurich”, then the proper desk identity is necessarily “London”, and the order takes on this value, and is processed in accordance with the set values for “London” (which, in this illustration, happens to be a blanket requirement for manual filling at 122 for all such orders.

As further depiction of this generalized exemplary flow process, each of the pending orders numbers 1-7, as referenced in detail above in Table A, are specifically processed according to the generalized exemplary flow, with order numbers 1-4 depicted in FIG. 9 (a)-(d), respectively, and order numbers 5-7 depicted in FIG. 9 (e)-(g), respectively. As can be seen, the pending (live) orders may appear on the screen of a trader/dealer 2, in the format indicated by Table A, and will be processed by the inventive system in the seven various exemplary scenarios as depicted therein, with certain decision branches depending only upon information of the Order itself (e.g. Amount) while other branches depend upon the conditions prevalent in the Fill itself (e.g. Partial Fill percentage).

External market sources 20 will provide a rate stream into the server environment 7 for integrated delivery to the screen of the trader/dealer 2 for display on his monitor, and for retrieval and use by the Autofill query at a given decision node in the flow process, and for ultimate execution by manual or Autofill means as appropriate. Some of the parameters to each order will necessarily originate from the customer 1, either by an application product 3 having a user interface (UI) such as seen in FIG. 7 (and which is most preferably supplied to him by the trader bank through the internet or other networked or telecommunications system 5) that can parse and transmit the selected data for communicated over electronic means such as the internet, telephonic, or other communication means 5 as known in the art of UI data intake and transmission. These parameters will typically include customer name (customer ID), trade type (buy/sell), asset type, amount, etc. Once these parameters are received in the server environment 7 of the trader bank, it will be routed through the rules base as previously set by administrator 10 (according to other parameters, such as trading desk parameters (similar to the “New York”/“Zurich”/“London” rules exemplified above). This may be done in an automated fashion by instantiating the previously discussed Autofills Rules Expressions 60 and Autofill Rules Hierarchy 64 (as discussed above) within the server environment 7 of the trader bank, so that by the time the trader/dealer 2 sees the listing of pending (live) orders illustratively depicted in Table A above, the Autofill. Rules are already applied to the system and ready to execute each respective trade, either manually, or on an Autofill basis as needed. When structured as such, yields the technical effect of transforming the customer's financial asset order desires into useful transaction signals that may then be transmitted by him and put into a useful form for receipt and automated processing by a trader bank into a tangible order result that can be transmitted back to the customer, and can deliver value to him, with minimal chance for human error during the entire processing.

It is to be understood that the invention is not limited to the illustrations described and shown herein, which are deemed to be more illustrative of the best modes of carrying out the invention, and which are susceptible of modification of form, size, and arrangement of parts and details operation. These modifications are within the spirit and scope of the appended claims.

We claim:

1. A method for processing financial transactions comprising the steps of:
identifying at least one transaction involving a financial asset;
associating attributes with said at least one transaction;
associating predicates with said attributes;
associating expressions with predicates;
receiving financial information relevant to said at least one transaction;
resolving said transaction based upon said financial information and in accordance with said expressions associated with said at least one transaction.

2. The method of claim 1 wherein said step of resolving said transaction further comprises offering the ability choose between resolving the transaction through a manual means method and an automatic means method in accordance with parameters associated with said transaction.

3. The method of claim 2 wherein said attributes are selected from the group comprising a desk ID, a customer ID, an asset ID, and pricing information.

4. The method of claim 3 wherein said financial asset is of a type selected from the group comprising foreign exchange, money market instruments, interest rate instruments, commodity instruments, equity instruments, and derivative instruments.

5. The method of claim 4 wherein said financial assets is of the foreign exchange type.

6. A method for processing financial transactions comprising the steps of:
identifying at least one transaction involving said financial asset;
conveying said at least one transaction to a financial transactions processing provider;
receiving a resolved transaction signal from said provider, said resolved transaction signal containing resolution information that is based upon said at least one order having been associated with attributes, said attributes having been associated with predicates, said predicates having been associated with expressions.

7. The method of claim 6 wherein said financial asset is of a type selected from the group comprising foreign exchange, money market instruments, interest rate instruments, commodity instruments, equity instruments, and derivative instruments.

8. The method of claim 7 wherein said financial assets is of the foreign exchange type.

9. A system for processing financial transactions involving a transaction for a financial asset comprising a computer based engine having:
an intake module for identifying at least one transaction involving said financial asset;
an attributes module for associating attributes with said at least one transaction;
a predicate module for associating predicates with said attributes;
an expressions module for associating expressions with predicates;
a receiving module for receiving financial information relevant to said at least one transaction;
a resolution module for generating a signal indicating a resolution of said transaction substantially based upon said financial information and in accordance with said expressions associated with said at least one transaction.

10. The system of claim 9 wherein said resolution module may be controlled according to a manual setting and an automatic setting in accordance with parameters associated with said transaction.

11. The system of claim 10 wherein said attributes module converts information selected from the group comprising a desk ID, a customer ID, an asset ID, and pricing information into an attributes sequence, and wherein said predicate module converts said attributes sequence into a predicates sequence, and wherein said expressions module converts said predicates sequence into an expression sequence, and wherein said resolution module generates said signal substantially from said financial information and from said expression sequence.

12. The system of claim 11 wherein said financial asset is of a type selected from the group comprising foreign exchange, money market instruments, interest rate instruments, commodity instruments, equity instruments, and derivative instruments.

13. The system of claim 12 wherein said system processes financial asset transactions involving a financial asset of the foreign exchange type.
